(19) United States
(12) Patent Application Publication
(10) Pub. No.: US 2007/0102989 A1
(43) Pub. Date: May 10, 2007

(54) Restraint safety device

(76) Inventors: Carrie L. Smith, San Diego, CA (US); Julie A. Brown, San Diego, CA (US); Nicholas E. Rambo, San Diego, CA (US); Aaron A. Brown, San Diego, CA (US)

Correspondence Address: John R. Ross, III, P.O. Box 2138, Del Mar, CA, 92014, US

(21) Appl. No.: 11/267,688

(22) Filed: Nov. 4, 2005

(51) Int. Cl. B60R 22/00

(52) U.S. Cl. 297/484

(57) ABSTRACT

A restraint safety device. A chest clip is slidingly attached to a first shoulder strap and a second shoulder strap. At least one chest clip stop is attached to each shoulder strap. The chest clip stops function to prevent or limit the sliding of the chest clip and to keep the chest clip properly positioned over the user's chest. In a preferred embodiment the restraint safety device is a child car seat and the user is a young child. Also, in a preferred embodiment, the chest clip stop is a button that may be removably positioned at an appropriate position on at least one of the shoulder straps. In another preferred embodiment, the chest clip stops remain in a permanent position on the shoulder straps and the position of the chest clip is adjusted by removing the chest clip from the shoulder straps and reattaching the chest clip at a desired position.

The present invention relates to restraint safety devices, and in particular, to child safety harness systems.

### BACKGROUND OF THE INVENTION

All states in the U.S. have laws of varying requirements regarding child safety seats for automobiles. For example, in California children must be secured in an appropriate child passenger restraint (safety seat or booster seat) in the back seat of a vehicle until they are at least 6 years old or weigh at least 60 pounds.

FIG. 1A shows prior art child car seat 1 and FIG. 1B shows a child strapped into prior art child car seat 1. Car seat 1 utilizes popular 5-point harness system 2 to secure the child. The 5-point harness system includes five straps: two shoulder straps 3A and 3B, two hip straps 4A and 4B, and 1 crotch strap 5. The length of shoulder straps 3A, 3B and hip straps 4A, 4B can be adjusted by pressing latch 91 to release compressive pressure on strap 92. Prior art child seat 1 is available from the Evenflow Corporation with Offices in Piqua, Ohio, Model No. 3261420.

After placing the child into the car seat, crotch strap 5 is drawn upwards between the child's legs and buckle tongues 7 (FIG. 2) are slid into buckle 6. Clip half 9A and Clip half 9B (FIGS. 3A and 3B) are snapped together to form chest clip 8 (FIG. 1B). Both halves 9A and 9B of chest clip 8 are free to slide up or down shoulder straps 3A and 3B so that clip 8 is appropriately positioned over the child's chest.

Applicants have discovered a dangerous problem with the car seat design described above.

What is needed is a better child safety seat.

### SUMMARY OF THE INVENTION

The present invention provides a restraint safety device. A chest clip is slidingly attached to a first shoulder strap and a second shoulder strap. At least one chest clip stop is attached to each shoulder strap. The chest clip stops function to prevent or limit the sliding of the chest clip and to keep the chest clip properly positioned over the user's chest. In a preferred embodiment the restraint safety device is a child car seat and the user is a young child. Also, in a preferred embodiment, the chest clip stop is a button that may be removably positioned at an appropriate position on at least one of the shoulder straps. In another preferred embodiment, the chest clip stops remain in a permanent position on the shoulder straps and the position of the chest clip is adjusted by removing the chest clip from the shoulder straps and reattaching the chest clip at a desired position.

### BRIEF DESCRIPTION OF THE DRAWINGS

FIGS. 1-4 show a prior art child safety seat.

FIGS. 5-7D show a preferred embodiment of the present invention.

FIGS. 8-11A show a preferred method for attaching preferred chest clip stops to the shoulder straps.

FIG. 11B shows a preferred method for removing chest clip stops.

FIGS. 12-15 show another preferred embodiment of the present invention.

FIG. 16 shows another preferred embodiment of the present invention.

FIG. 17 shows another preferred embodiment of the present invention.

FIGS. 18-20 show another preferred embodiment of the present invention.

FIGS. 21-24 show another preferred embodiment of the present invention.

### DETAILED DESCRIPTION OF THE PREFERRED EMBODIMENTS

### The Problem

FIG. 4 illustrates a dangerous problem associated with prior art child car seats, which was discovered by the one of the Applicants.

In FIG. 4, the child has grabbed chest clip 8 and has slid it down shoulder straps 3A and 3B so that it is no longer appropriately positioned over the child's chest, but instead is near buckle 6. The act of sliding chest clip 8 down shoulder straps 4 puts the child in a position of increased danger. For example, the child has wiggled her shoulders so that her upper body is no longer covered by shoulder straps 3A and 3B. At this point, if the automobile is involved in an accident, the child could potentially suffer head and/or neck injuries, which may include skull fractures, broken neck and jaw fractures, as well as injuries resulting from what is known as “Seat Belt Syndrome”. Seat Belt Syndrome has been characterized as a collection of injuries specifically resulting from passengers who were only wearing lap belts upon the impact of a vehicle crash. Injuries typically include: severe abdominal injuries, fractures of the lumbar spine and serious closed head and facial injuries-or even death because the upper body is no longer restrained.

Furthermore, from the position shown in FIG. 4 it is possible for the child to climb out of the 5-point harness system, placing her in even greater danger. If the child climbs out of the car seat and the car is involved in an accident, even a relatively minor accident, the child could suffer severe life threatening injuries.

### The Solution

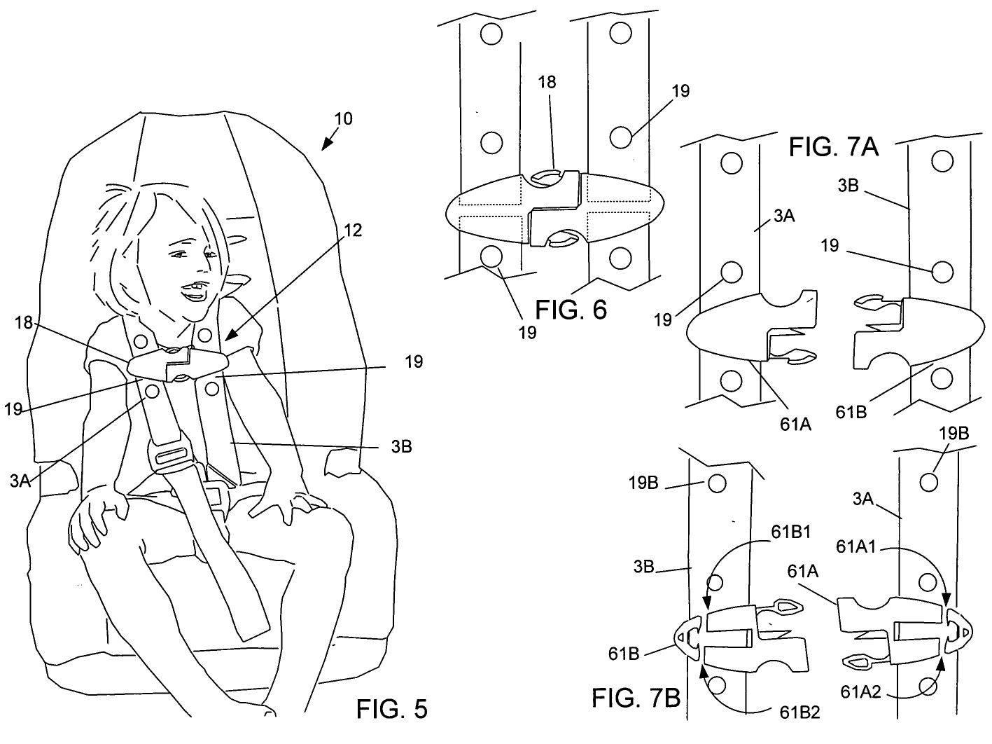

FIG. 5 shows a preferred embodiment of the present invention. Child safety seat 10 includes 5-point harness system 12. In 5-point harness system 12, chest clip 8 has been replaced with chest clip 18 and buttons 19 have been attached to shoulder straps 3A and 3B. In the first preferred embodiment, buttons 19 function as chest clip stops in that they stop the child from sliding chest clip 18 downward or upward, enabling chest clip 18 to remain appropriately positioned over the child's chest. Because chest clip 18 stays positioned over the child's chest, the child is prevented from escaping from the 5-point harness system and remains securely protected by the car seat harness system.

### Chest Clip

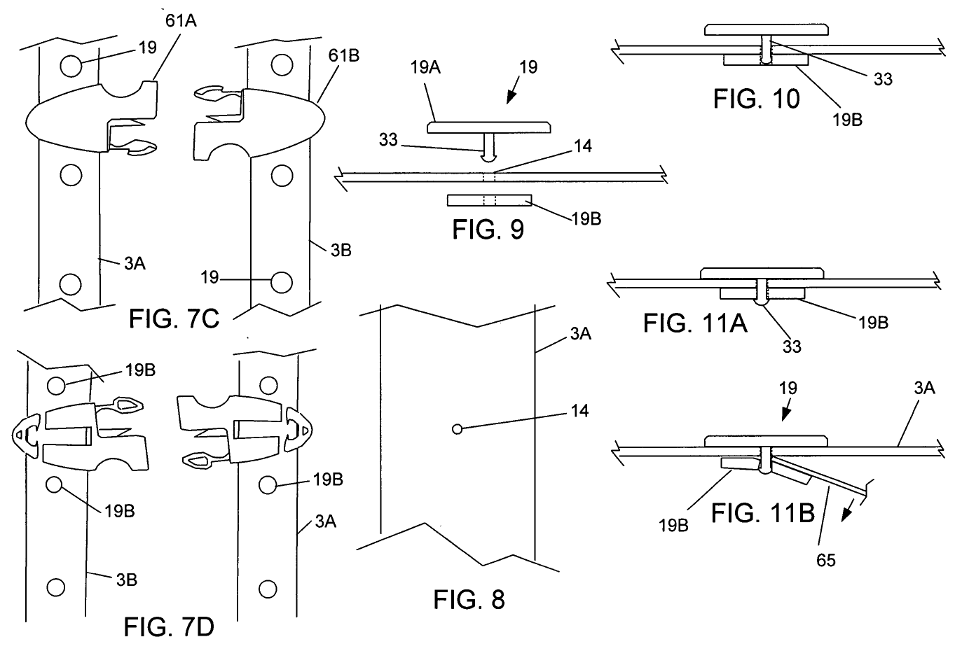

A front view of preferred chest clip 18 is shown in FIG. 7A and a rear view is shown in FIG. 7B. In a preferred embodiment, clip half 61A can be removed from shoulder strap 3A and clip half 61B can be removed from shoulder strap 3B.

### Buttons Attached to Shoulder Straps

FIG. 6 shows of chest clip 18 and buttons 19. As stated above, buttons 19 prevent the child from sliding clip 18 downwards or upwards. If the child attempts to move chest clip 18, the chest clip will contact the buttons 19 and the movement of chest clip 18 will be blocked by the buttons. Preferably, buttons 19 should be of sufficient thickness and diameter to prevent chest clip 18 from sliding over the buttons. A preferred portion of chest clip 18 located just underneath the cover of chest clip 18 is shown in dotted line in FIG. 6.

### Preferred Method of Attaching the Buttons to the Shoulder Straps

FIGS. 8-11A show a preferred method for attaching buttons 19 to the shoulder straps.

In FIG. 8, hole 14 has been punched through shoulder strap 3A.

In FIG. 9, upper part 19A of button 19 has been positioned over hole 14. Lower part 19B has been positioned under hole 14. Upper part 19A preferably includes ductile plastic barb 33.

In FIG. 10, barb 33 has been pushed through hole 14 and partially pushed through the hole in lower portion 19B.

In FIG. 11A, barb 33 has been pushed the rest of the way through the hole in lower portion 19B. Barb 33 is preferably ductile enough so that it can be squeezed through the hole in lower part 19B yet sufficiently firm so that it prevents lower portion 19B from separating after barb 33 has been completely pushed through the hole.

### Buttons Permanently Attached to Shoulder Straps

In the preferred embodiment shown in FIGS. 5-7B, buttons 19 are permanently attached to shoulder straps 3A and 3B in a manner similar to that shown in FIGS. 8-11B. As the child grows (or if a larger child uses the car seat), it will most likely be necessary to adjust the length of shoulder straps 3A and 3B and the length of hip straps 4A and 4B. Also, it may be necessary to adjust the position of chest clip 18 so that it remains appropriately positioned over the child's chest.

Because buttons 19 are intended to be permanently attached, an adult will need to remove chest clip 18 from shoulder straps 3A and 3B prior to repositioning chest clip 18. As shown in FIG. 7B, clip half 61B of chest clip 18 includes openings 61B1 and 61B2. Likewise, clip half 61A includes openings 61A1 and 61A2. To remove clip halves 61A and 61B from the shoulder straps, an adult slides straps 3A and 3B out through the openings.

For example, FIG. 5 shows a 3 year old child strapped in child car seat 10. Chest clip 18 is positioned as shown. Prior to placing a larger child (for example, a 6 year old child) into the car seat, the adult will need to increase the length of shoulder straps 3A and 3B and hip straps 4A and 4B. Accordingly, chest clip 18 has been raised so that it is positioned between a different set of buttons 19, as shown in FIGS. 7C and 7D. The position of chest clip 18 has been adjusted so that it will now be appropriately positioned over the larger child's chest.

### Buttons Removably Attached to the Shoulder Straps

FIG. 12 shows infant car safety seat 50 having 3-point harness system 51. 3-point harness system includes shoulder straps 52A and 52B and crotch strap 53.

An infant grows very fast and will commonly double their birth weight in the first 4 to 5 months of life. To accommodate the infant's fast growth, the shoulder straps of car safety seat 50 may need to be adjusted every 2 to 3 weeks. Because the alignment between relative positions on strap 52A and 52B shifts as the straps are being lengthened it is preferable to remove buttons 19 prior to adjusting the lengths of straps 52A and 52B. Then, buttons 19 should be reattached after the lengths of straps 52A and 52B have been adjusted.

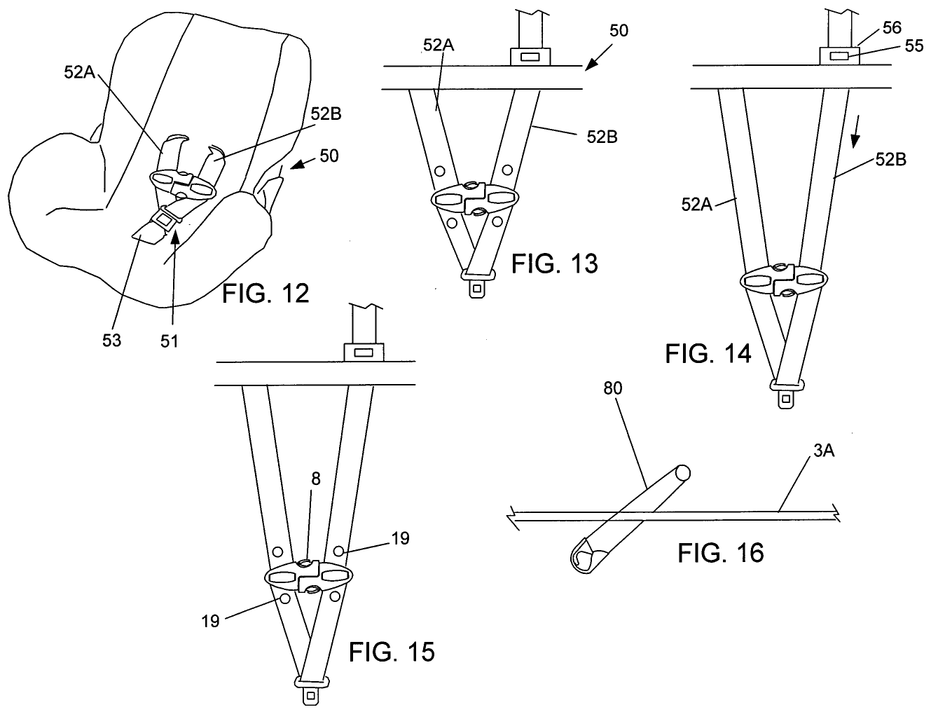

For example, FIG. 13 shows a simplified top view of shoulder straps 52A and 52B of car seat 50.

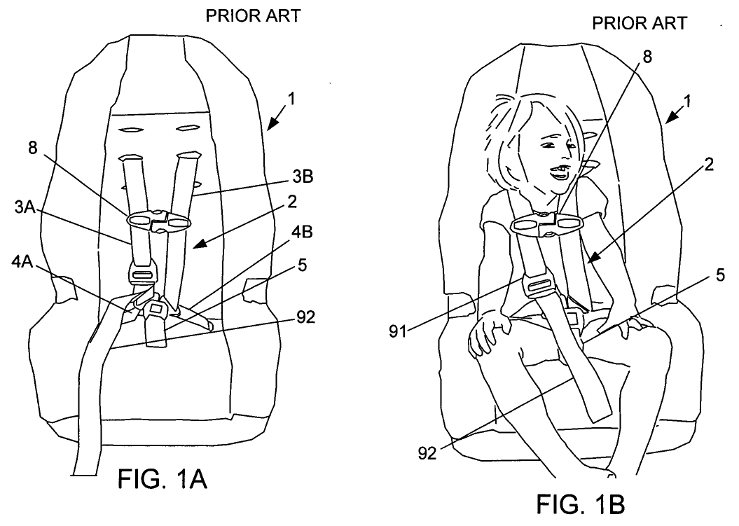

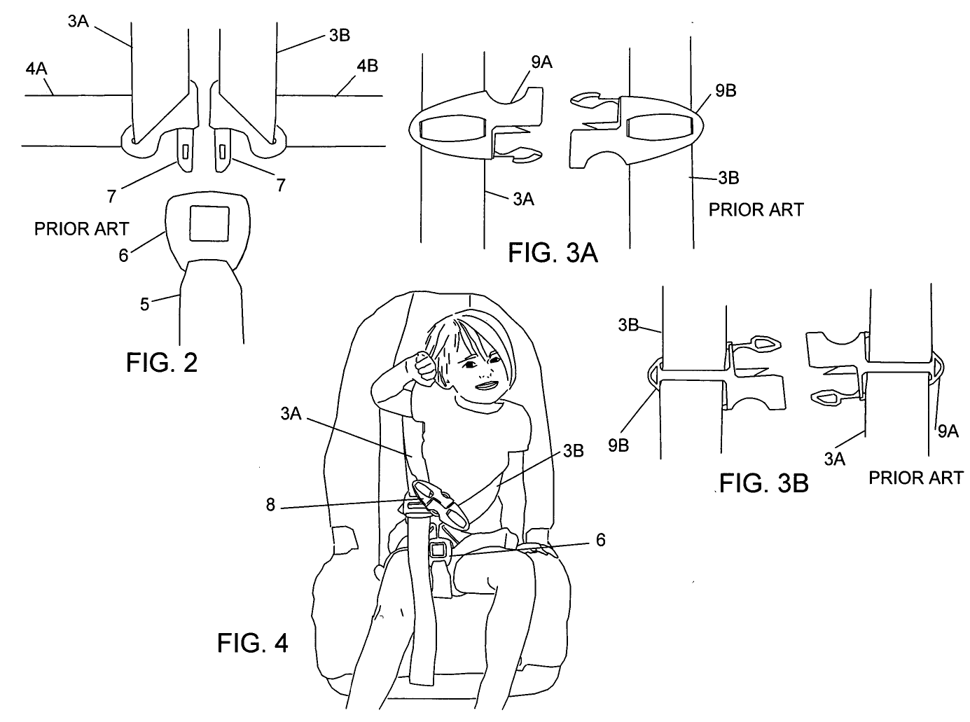

In FIG. 14, an adult has removed buttons 19. A preferred method for removing buttons 19 is shown in FIG. 1B. Hard flat tool 65 is inserted between strap 3A and backing 19B. Backing 19B is then pried off.

Then, as shown in FIG. 14, an adult has reached behind car seat 50 and has pressed button 55 of latch 56. This releases compressive pressure on strap 52B and has allowed the adult to pull strap 52B in the direction indicated by the arrow in FIG. 14 to lengthen shoulder straps 52B and 52A.

In FIG. 15, the adult has appropriately adjusted the position of chest clip 8 and has reattached buttons 19 in a fashion similar to that described above in reference to FIGS. 8-11A.

### Alternate Applications

Although the above preferred embodiments specifically showed how the present invention can be utilized for child safety seat harnesses, it can likewise be utilized for a variety of other applications. For example, buttons 19 (or a similar stop) can be utilized for but not limited to preventing sliding of a chest clip for the following devices: an infant/toddler front carrier, a stroller, a grocery cart infant seat, a highchair, an infant/toddler backpack carrier, car booster seats, a jogging stroller. There are adult applications for the present invention as well. For example, automobile race car drivers usually utilize shoulder straps as part of their safety harnessing system. Buttons 19 attached to the shoulder straps of an automobile racer can prevent unwanted sliding of a chest clip. This idea could also apply to outdoor recreational safety gear as well as safety restraints used by medical personnel.

### Decorative Buttons

In another preferred embodiment, buttons 19 include a design on the front that is decorative and visually appealing to enhance the attractiveness of the car seat.

### Decorative Chest Clip Cover

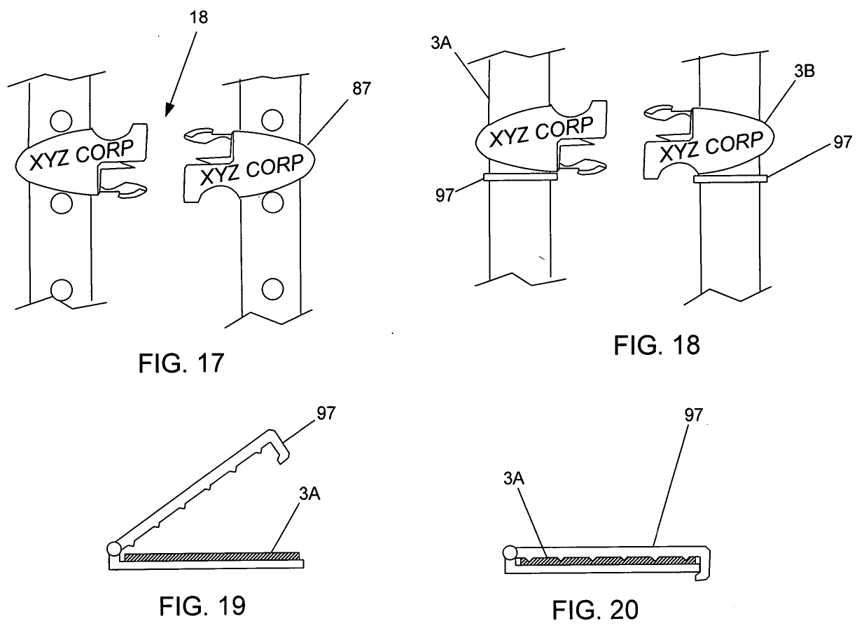

In another preferred embodiment, chest clip 18 (FIG. 6) includes cover 87 (FIG. 17) that preferably includes the logo of the seat supplier.

### Snaps as Chest Clip Stops

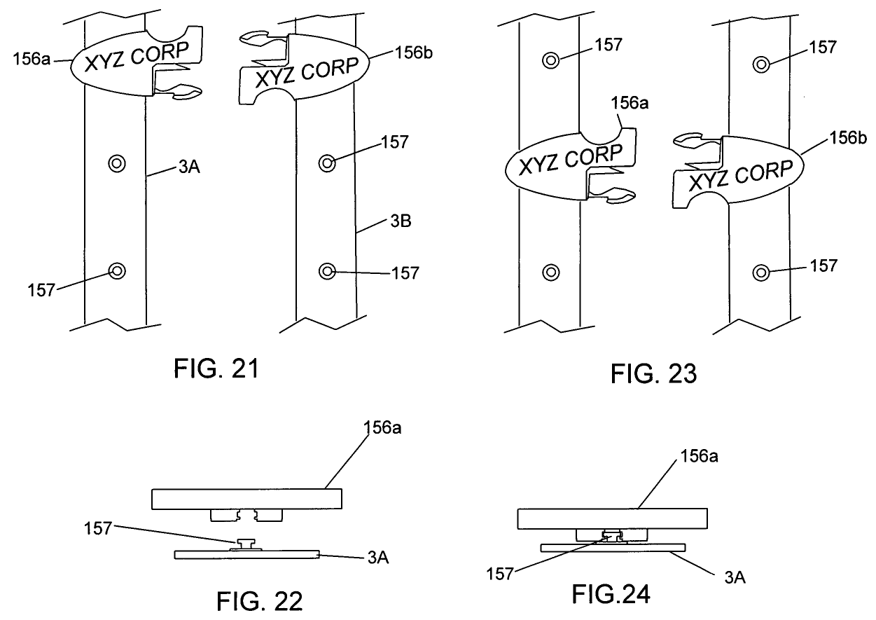

In another preferred embodiment, snaps are utilized as chest clip stops. For example, FIG. 21 shows chest clip stop halves 156a and 156b snapped to shoulder straps 3A and 3B. Snaps 157 are attached to shoulder straps 3A and 3B.

In FIG. 22, the parent has unsnapped chest clip stop half 156a from shoulder strap 3A. The parent then also unsnaps chest clip stop half 156b in a similar manner.

In FIG. 23, the parent has snapped chest clip stop halves 156a and 156b back onto shoulder straps 3A and 3B in different positions. FIG. 24 shows a side view of chest clip stop half 156a snapped onto strap 3A.

Although the above-preferred embodiments have been described with specificity, persons skilled in this art will recognize that many changes to the specific embodiments disclosed above could be made without departing from the spirit of the invention. For example, although the above preferred embodiments showed a plurality of chest clip stops on the shoulder straps, it would be possible to prevent or limit the sliding of the chest clip by utilizing just one chest clip stop. Also, although the above preferred embodiments showed buttons 19 attached to shoulder straps 3A and 3B, it would be possible to attach other objects to the shoulder straps to prevent the chest clip from sliding. For example, FIG. 16 shows safety pin 80 attached to shoulder strap 3A. Safety pin 80 would stop the sliding of chest clip 8 or 18 in a manner similar to buttons 19. Preferably, a plurality of safety pins would be utilized and they would be attached above and below the chest clip in a fashion similar to buttons 19 shown in FIG. 15. Also, a simple stop in the general shape of a hair barrette can be designed to operate as a chest clip stop. For example, FIG. 18 shows chest clip stop 97 clamped down onto shoulder straps 3A and 3B. Also, FIG. 19 shows a front view of chest clip stop 97 opened and FIG. 20 shows a front view of chest clip stop 97 clamped down onto shoulder straps 3A and 3B. With chest clip stop 97, there is no need to modify clip halves 9A and 9B shown in FIG. 3A. Also, it should be noted that a variety of objects that penetrate the shoulder straps other than a button or a safety pin could be utilized. Some of the many possibilities include a paper clip, a thumb tack, or a pin. If a thumb tack or a pin is utilized the sharp end should be covered with a backing. For example, a preferred backing would screw onto the sharp end of the pin or thumb tack. Also, in addition to the hair barrette shown in FIGS. 18-20, other devices that wrap around the shoulder straps can also be utilized as chest clip stops. For example, fabric can be tied tightly around the shoulder straps. Or duct tape wrapped around the shoulder straps can function as a chest clip stop. Also, it would be possible to run the shoulder straps through a plurality of buckles and utilize the buckles as chest clip stops. Also, it would be possible to attach to the chest clip an object designed to minimize or prevent the sliding or movement of the clip. This object would serve as a redundancy feature that would operate to prevent the sliding and movement of the chest clip in addition to the chest clip stops. For example, the chest clip could include teeth such as teeth on a hair barrette (see FIGS. 18-20), or a non-skid type of rubber or plastic. Also, in another preferred embodiment, shoulder straps 3A and 3B each include a plurality of prefabricated holes (such as hole 14 shown in FIG. 8). The parent then may then install, remove and replace chest clip stops of whatever form is appealing to the parent (for example, buttons, pins with backings, buckles, safety pins, hair barrettes, etc.). Also, it should be noted that it would be possible to attach buttons 19 in a variety of ways. For example, buttons 19 can be sewn onto shoulder straps 3A and 3B with a needle and thread at the exact position that the parent desires. Then, if it ever becomes necessary to adjust the location of the chest clip, the parent merely need to just cut the thread and move the buttons to the desired location and sew them onto the straps again. By sewing buttons onto the shoulder straps and then re-sewing them at different locations, there is no need to modify clip halves 9A and 9B shown in FIG. 3A. Also, above in the specification in reference to FIGS. 12-15 it is described how buttons 19 are removed when the length of shoulder straps 52A and 52B are adjusted and the position of chest clip 18 is adjusted. It should be recognized that it would also be possible to attach a plurality of buttons 19 to shoulder straps 52A and 52B. Then, to adjust the length of shoulder straps 52A and 52B the buttons can remain attached to the shoulder straps and the chest clip would be removed and reattached appropriately in a fashion similar to that described above in reference to FIGS. 7A-7D. Therefore, the attached claims and their legal equivalents should determine the scope of the invention.

1) A restraint safety device, comprising:
A) a first shoulder strap,
D) a second shoulder strap
C) a chest clip slidingly attached to said first shoulder strap and said second shoulder strap, and
D) at least one chest clip stop attached to said first shoulder strap or said second shoulder strap,
wherein said at least one chest clip stop prevents sliding of said chest clip.

2) The restraint safety device as in claim 1 wherein said at least one chest clip stop is two chest clip stops.

3) The restraint safety device as in claim 1 wherein said at least one chest clip stop is a plurality of chest clip stops.

4) The restraint safety device as in claim 1 wherein said restraint safety device is utilized on a child car seat.

5) The restraint safety device as in claim 1 wherein said at least one chest clip is for keeping said chest clip positioned over a user's chest

6) The restraint safety device as in claim 1 wherein said chest clip is removably attached to said first shoulder strap and said second shoulder strap.

7) The restraint safety device as in claim 6 wherein said at least one chest clip stop is permanently attached to said first shoulder strap and said second shoulder strap.

8) The restraint safety device as in claim 1 wherein said chest clip is permanently attached to said first shoulder strap and said second shoulder strap.

9) The restraint safety device as in claim 8 wherein at least one chest clip stop is removably attached to said first shoulder strap and said second shoulder strap.

10) The restraint safety device as in claim 1 wherein said at least one chest clip stop is a plurality of buttons.

11) (canceled)

12) (canceled)

13) (canceled)

14) (canceled)

15) (canceled)
